(19) United States
(12) Patent Application Publication
(10) Pub. No.: US 2017/0034377 A1
(43) Pub. Date: Feb. 2, 2017

(54) IMAGE READING APPARATUS, CONTROL METHOD FOR IMAGE READING APPARATUS, AND STORAGE MEDIUM

(71) Applicant: CANON KABUSHIKI KAISHA, Tokyo (JP)

(72) Inventor: Tomonori Hayashi, Nagareyama-shi (JP)

(21) Appl. No.: 15/217,848

(22) Filed: Jul. 22, 2016

(30) Foreign Application Priority Data
Jul. 30, 2015 (JP) 2015-150503

(51) Int. Cl. H04N 1/00; H04N 1/32

(52) U.S. Cl. CPC H04N 1/00811; H04N 1/00013; H04N 1/00037; H04N 1/00925; H04N 1/32101; H04N 2201/0094; H04N 2201/3205

(57) ABSTRACT

An image reading apparatus equipped with a reading unit includes a control unit that, in a state where reading processing is in progress based on an instruction from a first user, if a second user logs into the image reading apparatus while execution of the reading processing continues after the first user logs out of the image reading apparatus, restricts usage of the reading unit by the second user, an acceptance unit that accepts an instruction to stop or complete the reading processing from the second user after the usage of the reading unit has been restricted, wherein the control unit permits the second user to use the reading unit after the reading processing has stopped or completed.

### BACKGROUND

Field

Aspects of the present invention generally relate to an operation control performed in a case where an image reading apparatus is used by a plurality of users.

Description of the Related Art

A multi-function peripheral can be installed in an office environment as an integrated device including scanner, printer, and facsimile functions. An advanced multi-function peripheral includes many functions to satisfy various user needs. For example, as a copy function, the multi-function peripheral can scan a paper document and copy a document image on a paper. Further, as a scan and send function, the multi-function peripheral can scan a paper document and transmit a facsimile (fax) based on the obtained data. As a print function, the multi-function peripheral can perform a print operation based on print data transmitted via LAN. As an additional function, the multi-function peripheral can store data for reprint and perform a reprint operation based on previously stored data.

In general, many different users use the multi-function peripheral in an office environment. There is a case where a user occupies the multi-function peripheral for an extended period of time. If the multi-function peripheral is occupied by such a user, other users cannot operate the multi-function peripheral to use another functions. As a result, these users must wait until the current user finishes using the multi-function peripheral.

For example, in one situation, a first user currently logged into a multi-function peripheral is operating the scanner to convert a significant amount of paper documents into electronic data. A second user may want to use the printer to print previously stored data. In such a case, the second user cannot start printing until the first user logs out of the multi-function peripheral.

As discussed in Japanese Patent Application Laid-Open No. 2007-174062, there is a conventionally known method that suppresses the above-described occurrence of down time on the part of users. More specifically, the conventional method is characterized by accepting a logout operation by a currently operating user while document reading processing is in progress based on an instruction from the currently operating user. When the multi-function peripheral receives the logout operation of the currently operating user, the multi-function peripheral executes logout processing for the currently operating user without stopping execution of the document reading processing. Then, if the multi-function peripheral receives a login request from another user, the multi-function peripheral permits the login of that user even in a state where the document reading processing is not yet completed, so that user can operate the multi-function peripheral.

According to the above-described method, the multi-function peripheral permits another user (hereinafter, referred to as “user B”) to log in while the document reading processing instructed by the currently operating user (hereinafter, referred to as “user A”) continues. The multi-function peripheral permits user B to use any function if it does not use the scanner (e.g., the function of printing stored data). As a result, user friendliness improves significantly since it is unnecessary for user B to wait until the document reading processing for user A completes.

User B, however, cannot use any scanner related functions, such as the copy function and the scan and send function, unless the document reading processing instructed by user A completes.

In some cases, the document reading processing may need to receive a user instruction during a period between the start and completion of the processing. For example, take a case where continuous reading is designated. In such a case, after the reading of a document bundle placed on a document feeder is completed, the document reading processing is brought into a standby state to wait for a user instruction to start an operation to read the next document bundle. When the processing is brought into such a user instruction standby state, only the user who started the processing can typically restart the processing. More specifically, according to the above-described example, only user A can cancel the instruction standby state when user A is the user who instructed the document reading processing.

In another example, the processing can include a designation of preview to be performed before transmission. If the preview to be performed before transmission is designated, a preview display is performed on an operation unit. The user is required to confirm a preview result and the reading processing completes only when the user instructs the transmission. Therefore, even in a case where the preview to be performed before transmission is designated, the processing is brought into the above-described user instruction standby state.

Even in a case where a paper jam error occurs during the reading processing, the user who instructed the reading processing is required to perform a recovery operation to restart the processing.

As described above, the document reading processing temporarily stops its operation when the processing is brought into the user instruction standby state or when an error occurs. However, an instruction to restart the temporarily stopped reading processing can be accepted only when the user who instructed the processing is in a login state. According to the above-described example, if the document reading processing is brought into the instruction standby state after user B has logged in the multi-function peripheral in a state where the document reading processing instructed by user A is in progress, cancelling the instruction standby state is feasible only by user A who is in the login state. More specifically, unless user A logs into the multi-function peripheral again, other users cannot use any function executable based on the scanner.

Accordingly, what is needed is a capability to stop or complete a document reading processing in order to enable efficient use of a multi-function peripheral.

### SUMMARY

According to an aspect of the present invention, an image reading apparatus includes a reading unit configured to perform reading processing for reading an original document, a control unit configured to permit a second user, different from a first user, to use at least one function of the image reading apparatus if the at least one function does not use the reading unit and restrict usage of a function using the reading unit until the reading processing completes, based on a login of the second user into the image reading apparatus while execution of the reading processing continues after the first user logs out of the image reading apparatus while the reading processing is in progress based on an instruction from the first user who logged into the image reading apparatus, and an acceptance unit configured to accept an instruction from the second user to stop or restart the reading processing that was temporarily stopped to wait for at least a user instruction while the usage of the function using the reading unit is restricted.

Further features of the aspects of the present invention will become apparent from the following description of exemplary embodiments with reference to the attached drawings.

### BRIEF DESCRIPTION OF THE DRAWINGS

FIG. 1 is a block diagram illustrating an example hardware configuration of a multi-function peripheral (MFP).

FIG. 2 is a block diagram illustrating an example software configuration of the MFP.

FIG. 3 illustrates an example main menu in which the usage of a function performed using a scanner is restricted.

FIGS. 4A, 4B, and 4C illustrate example screens each displaying a status of a background job.

FIG. 5 illustrates an example screen that displays a status of a background job over the main menu.

FIGS. 6A, 6B, and 6C are flowcharts illustrating processing for displaying a status of a background job and stopping the background job.

FIG. 7 is a flowchart illustrating processing for allowing a user to stop a background job in a temporarily stopped state.

FIG. 8 is a flowchart illustrating processing for allowing a user to stop a background job after a predetermined time has elapsed.

FIG. 9 illustrates an example screen that displays the status of a background job.

FIG. 10 is a flowchart illustrating processing for displaying a status of a background job and forcibly executing the background job.

FIG. 11 illustrates an example job management table.

FIG. 12 illustrates an example interrupt management table.

FIG. 13 illustrates an example background job stop management table.

### DESCRIPTION OF THE EMBODIMENTS

Hereinafter, exemplary embodiments of the present invention will be described in detail below with reference to the attached drawings.

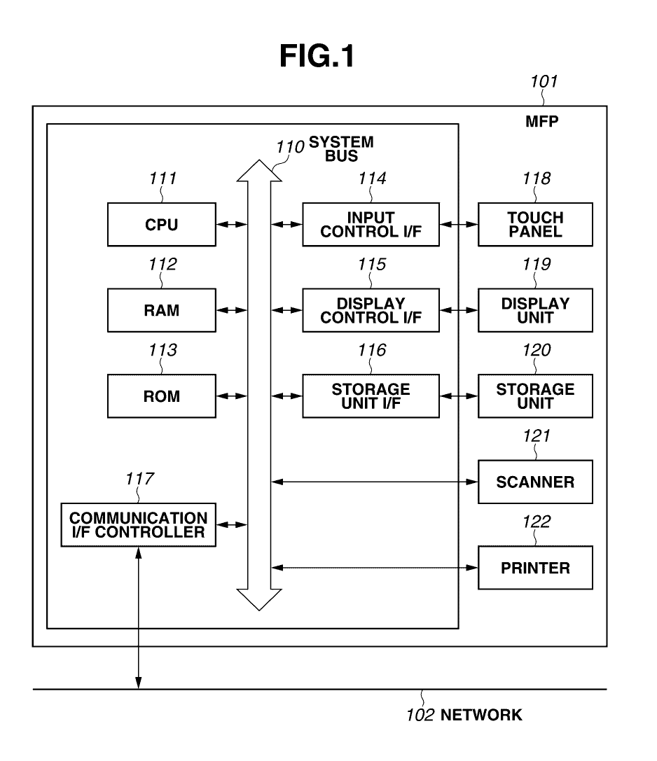

FIG. 1 illustrates an example of a hardware configuration of a multi-function peripheral (MFP) 101. The MFP 101 is an example of the image reading apparatus.

A central processing unit (CPU) 111, a random access memory (RAM) 112, a read only memory (ROM) 113, an input control I/F 114, a display control I/F 115, a storage unit I/F 116, and a communication I/F controller 117 are connected to a system bus 110. Further, a scanner 121 and a printer 122 are connected to the system bus 110. Each constituent component connected to the system bus 110 is configured to transmit and receive data to and from other constituent components via the system bus 110.

The CPU 111 is a device that can control each unit and can calculate and modify data. The RAM 112 is a volatile memory. The RAM 112 can be used as a temporary storage area, such as a main memory or a work area, for the CPU 111. The ROM 113 is a nonvolatile memory that can store image data, other data, and various programs that can be executed by the CPU 111 respectively in predetermined storage areas. For example, the CPU 111 can control each unit of the MFP 101 according to programs stored in the ROM 113, while using the RAM 112 as a work memory. The programs for operating the CPU 111 can also be stored in a storage unit 120.

The input control I/F 114 can accept a user operation and generate a control signal corresponding to the operation. The generated signal is supplied to the CPU 111. For example, the input control I/F 114 is connected to, as an input device capable of accepting each user operation, hard keys operable to directly input character information and numerical values, and a pointing device (e.g., a touch panel 118). The touch panel 118 is, for example, an input device configured to output coordinate information representing a touched position on an input pad configured to have a flat surface. In the present exemplary embodiment, the touch panel 118 is used as an input device, but the input device according to the present exemplary embodiment is not limited to the touch panel. The CPU 111 can control each unit of the MFP 101 according to a program based on a control signal generated and supplied by the input control I/F 114 in response to a user operation performed with the input device. Therefore, it is feasible to cause the MFP 101 to perform an operation according to a user operation.

The display control I/F 115 can output a display signal to cause a display unit 119 to display an image. For example, the CPU 111 generates a display control signal according to a program and supplies the display control signal to the display control I/F 115. The display control I/F 115 generates a display signal based on the received display control signal and outputs the display signal to the display unit 119. For example, the display control I/F 115 causes the display unit 119 to display a GUI screen that configures a graphical user interface (GUI) based on the display control signal generated by the CPU 111. Further, the touch panel 118 can be integrated with the display unit 119. For example, the touch panel 118 is attached to an upper layer of a display surface of the display unit 119 in such a way as to prevent light transmittance from disturbing the display of the display unit 119. Further, input coordinates on the touch panel 118 are associated with display coordinates on the display unit 119. Thus, it is feasible to constitute the GUI that gives each user a feeling as if the user can directly operate a screen displayed on the display unit 119.

The storage unit I/F 116 is connected to the storage unit 120, which can be as a hard disk drive (HDD), a flash memory, etc.. Processing for reading and writing data from and to the storage unit 120 is performed under the control of the CPU 111. In realizing the required functions, the RAM 112 or the ROM 113 can be partly replaced by the storage unit 120.

The communication I/F controller 117 can perform communications via a local area network (LAN), the internet, or wired/wireless network, under the control of the CPU 111. A PC, another MFP, a printer, and a server are connected to a network 102, so as to enable communication with the MFP 101.

The scanner 121 is an apparatus that irradiates a paper document with light and read the reflected light as digital data. The scanner 121 is equipped with a document positioning glass on which a document can be placed to read information about each surface of the document. Further, the scanner 121 is equipped with an auto document feeder (ADF) for continuously reading a plurality of stacked documents. For example, the CPU 111 causes the scanner 121 to perform document reading processing based on a user instruction input via the input control I/F 114. The scanner 121 stores generated image data in the storage unit 120 via the storage unit I/F 116. The scanner 121 is an example of a reading unit. In the present exemplary embodiment, as described below, the MFP 101 provides a copy function, a FAX function, a scan and send function, and a box saving function to users as functions using the scanner 121.

The printer 122 can perform print processing of the image data stored in the storage unit 120 under the control of the CPU 111. For example, the CPU 111 causes the printer 122 to perform print processing according to a user instruction input via the input control I/F 114 or a command instruction input from an external apparatus via the communication I/F controller 117. The printer 122 can print an image on a paper sheet supplied from a paper feeding unit (not illustrated). The paper feeding unit is a cassette feeder unit that can supply a great amount of sheets each having a specific size (e.g., A4 or A5) or a manual feeder unit that allows a user to manually supply papers. The printer 122 reads image data from the storage unit 120 and converts the read data into appropriate image data having a data format suitable for the printing. The printer 122 performs printing on a paper document.

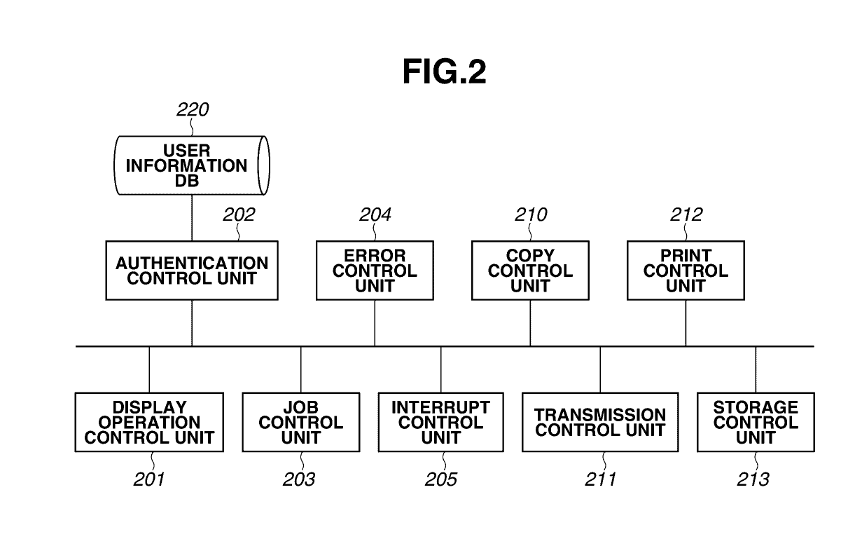

A software configuration of the MFP 101 will be described in detail below with reference to FIG. 2. Each control unit illustrated in FIG. 2 is stored in the ROM 113 or the storage unit 120 and can be loaded into the RAM 112, if necessary, for example, when the MFP 101 is activated or the usage of a function is instructed, and can be controlled by the CPU 111.

The MFP 101 includes control units dedicated to the copy function, the FAX function, the scan and send function, and the box saving function, respectively. The example software configuration illustrated in FIG. 2 includes a copy control unit 210, a transmission control unit 211, and a print control unit 212. In addition to the functions illustrated in FIG. 2, the MFP 101 includes control units dedicated to other functions relating to the processing of the MFP 101. The MFP 101 issues a job if each functional control unit starts processing thereof. Each job that is currently in progress can be notified to a job control unit 203 described below.

A display operation control unit 201 can control the input control I/F 114 and the display control I/F 115 under the control of the CPU 111. For example, the display operation control unit 201 causes the display unit 119 to perform a display operation based on an instruction from another control unit, via the display control I/F 115. The display operation control unit 201 acquires information input by a user on the touch panel 118, via the input control I/F 114.

An authentication control unit 202 can perform authentication processing for identifying a user under the control of the CPU 111 and can determine whether the operator (i.e., the user) of the MFP 101 is a valid user of the MFP 101. Performing the authentication processing and starting a session for a valid user is referred to as “login”. Further, the authentication control unit 202 can control a database that stores user information to be processed by the storage unit 120 (hereinafter, referred to as “user information DB 220”). In addition to the user information DB 220 of the MFP 101, the authentication control unit 202 can communicate with an external authentication server via the communication I/F controller 117 and use an authentication result obtained by the external authentication server. A conventional technique is usable to acquire authentication information from the external authentication server. Further, terminating the above-described session for the valid user when the user terminates the usage of the MFP 101 is referred to as “logout”.

The authentication control unit 202 provides functions of registering, deleting, and updating user information. Further, the authentication control unit 202 can provide a group function. The group is an assembly of a plurality of users. The authentication control unit 202 can register a plurality of groups. Each user can belong to none or at least one of the plurality of groups. The authentication control unit 202 provides functions of registering, deleting, and updating each group, and causing each user to belong to or withdraw from a group. The authentication control unit 202 stores information about an identifier that uniquely identifies each user (hereinafter, referred to as “user identifier”) and an identifier that uniquely identifies each group (hereinafter, referred to as “group identifier”) in the user information DB 220. The user information DB 220 is stored in the storage unit 120.

Sequential processing performed in each of the scan, print, transmission, and copy functions of the image forming apparatus is referred to as “job”. For example, a transmission job includes sequential processing for reading an original document with the scanner 121 and transmitting the acquired document data. A print job is sequential processing for causing the printer 122 to print a document. For example, in the present exemplary embodiment, the transmission job is sequential processing for reading an original document with the scanner 121 and transmitting a FAX or a mail including the acquired document data. However, processing for scanning a document may be regarded as an independent scan job. In this case, the scan job performs processing for reading an original document with the scanner 121 and the transmission job performs processing for transmitting a FAX or a mail including the acquired document data. The scan job and the transmission job can be combined with each other to perform document reading and transmitting processing sequentially.

In an environment where authentication is set to always be performed, each job is associated with a user identifier that uniquely identifies a job execution owner. Therefore, it is feasible to prevent a user other than the job owner from cancelling the job designated by the job owner.

The job control unit 203 can manage jobs of the above-described functions. The job control unit 203 issues a unique job identifier in response to a job registration instruction from the control of each function. In response to a job status inquiry from each control unit, the job control unit 203 transmits a response informing the status of currently progressing job. Further, in addition to the above-described job status management, the job control unit 203 can perform a control to display the status of each job that is currently in progress and results of completed jobs, although not illustrated in the drawings.

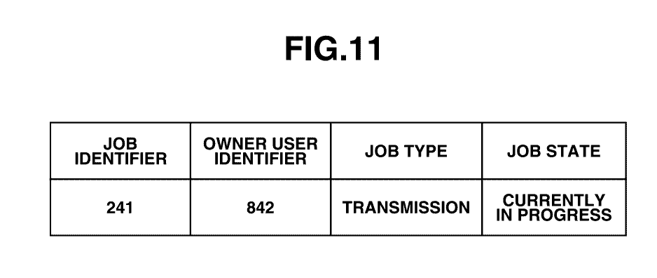

FIG. 11 illustrates an example of a job management table used by the job control unit 203 to manage jobs. The job management table illustrated in FIG. 11 includes a combination of record fields that can store information about job identifier, job owner user identifier, job type (e.g., transmission job or print job), and job status (e.g., currently in progress, completed, or cancelled).

The job management table illustrated in FIG. 11 includes the limited information about job identifier, owner user identifier, job type, and job status. However, the job management table according to the present exemplary embodiment can include other job related information.

Next, to describe an interrupt control unit 205, interrupt login will be described in detail below. Hereinafter, it is assumed that there are two users, user A and user B. The interrupt login means that the other user B performs a login operation to use the image forming apparatus in a state where a job (e.g., a scan job or a print job) is currently in progress for the user A who has logged in earlier. In this case, the user B cannot start an operation (or cannot start using any function) that uses the hardware resource occupied by the job designated by the user A, because the operation for the job designated by the user A continues in the background.

For example, it is now assumed that the user A is currently using the scan function to perform FAX transmission. In this case, the other user B cannot start any function that needs the scanner 121 because the scanner 121 is occupied by the user A. For example, the user B cannot transmit a mail including a scanned image. However, the user B can start using the print function that uses only the printer 122 without using the scanner 121. For example, the user B can operate the printer 122 to print a document stored in the image forming apparatus. On the other hand, in a case where the user A is currently using the print function to cause the printer 122 to perform a print operation, the printer 122 is occupied by the print job designated by the user A. In this case, the other user B can start the function executable using the scanner 121, such as FAX transmission, without using the printer 122.

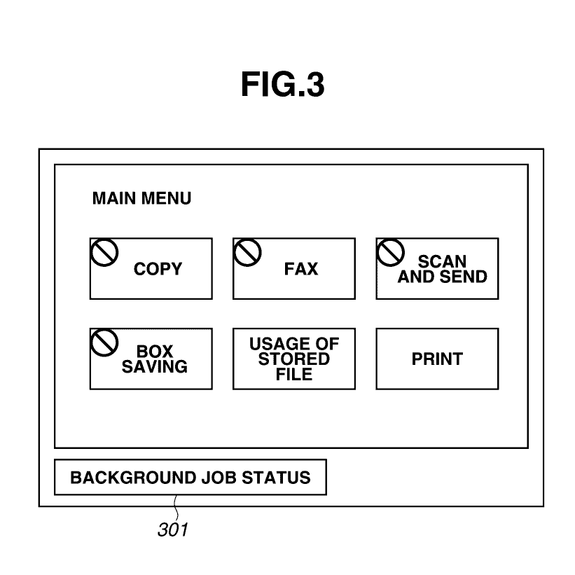

As described above, when the user B performs the interrupt login, the user B cannot start any function that needs the hardware resource occupied by the job designated by the user A. Therefore, the display unit 119 is controlled so as to prevent each unavailable function from being selected (see FIG. 3).

FIG. 3 illustrates a state where the user A is using the FAX function and the scanner 121 is occupied by a transmission job designated by the user A. In other words, it is unfeasible to use any function that needs the scanner 121 (e.g., any one of the copy, FAX, scan and send, and box saving functions). Therefore, it becomes unfeasible to press the corresponding buttons on the illustrated screen. More specifically, the job control unit 203 identifies a hardware resource that is occupied by the currently progressing job. The display operation control unit 201 manages the resources to be used by respective functions. For example, it is useful to prepare a table that can manage the relationship between each function and a hardware resource to be used. In this case, based on the management table, the display operation control unit 201 is instructed to perform a display control so as to prevent unavailable functions from being selected.

In the present exemplary embodiment, selecting an unavailable function is unfeasible by the display operation control unit 201. Alternatively, the display operation control unit 201 can be configured to display an error message if the button of an unavailable function is selected.

In the present exemplary embodiment, it is assumed that the user A logs out when the user B has logged in and execution of the job of the user A continues in the background, and further it is assumed that the user A logs in again after termination of the usage by the user B. As another situation, it can be assumed that the user A remains in the login state when the user B has logged in and the operation returns to the state where the user A has logged in after the termination of the usage by the user B. More specifically, the interrupt control unit 205 can cause the job of the user A to operate in the background in response to the login of the user B or can cause the job to operate in the background in response to the logout of the user A.

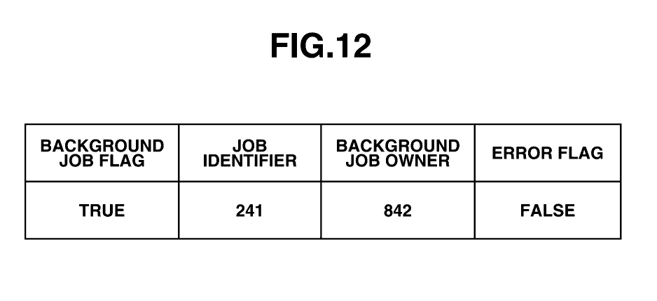

The interrupt control unit 205 manages and controls the interrupt state. The interrupt control unit 205 has an interrupt management table for the management of the interrupt state. FIG. 12 illustrates an example of the interrupt management table.

A background job flag determines whether a job is operating in the background in the logout state, or a job of a user who is different from the user operating the image forming apparatus is operating in the background. If the background job flag is TRUE, it indicates that there is a job operating in the background. If the background job flag is FALSE, it indicates that there is not any job operating in the background. The job identifier of a job operating in the background is recorded in the “job identifier” field of the interrupt management table (see FIG. 12). The user identifier of a job owner is recorded in the “background job owner” field of the interrupt management table (see FIG. 12). An error flag indicates whether an error has occurred in a job operating in the background. If the error flag is TRUE, it indicates that an error has occurred in the job operating in the background. If the error flag is FALSE, it indicates that no error has occurred in the job operating in the background. In the present exemplary embodiment, only one job is currently managed in the interrupt management table. However, the interrupt management table can be used to manage a plurality of jobs unless there is conflict with respect to the hardware resource.

When the interrupt login is performed, the authentication control unit 202 transmits a logout notification to the interrupt control unit 205 at the logout timing. The interrupt control unit 205 receives the logout notification from the authentication control unit 202 and instructs the job control unit 203 to confirm whether there is a currently progressing job. If there is a job that is currently in progress, the interrupt control unit 205 sets the background job flag to TRUE.

At the login timing, the authentication control unit 202 transmits a login notification to the interrupt control unit 205. The login notification includes the user identifier of a login user who uses the image forming apparatus. The interrupt control unit 205 receives the login notification from the authentication control unit 202 and reads the background job flag from the interrupt management table (see FIG. 12). If the background job flag is FALSE, the interrupt control unit 205 performs no processing. If the background job flag is TRUE, the interrupt control unit 205 reads the background job owner from the interrupt management table (see FIG. 12) and compares the acquired information with the user identifier of the login user notified from the authentication control unit 202. If the compared data coincide with each other, the interrupt control unit 205 determines that the interrupt has been cancelled and clears the background job flag.

If the user identifier of the login user notified from the authentication control unit 202 does not coincide with the job identifier of the background job owner, the interrupt control unit 205 determines that the interrupt login has been performed. If it is determined that the interrupt login has been performed, the interrupt control unit 205 performs a control in such a way as to prevent the above-described unavailable function from being select. The content of the above-described prevention control is not the essential part of aspects of the present invention, and redundant description thereof is omitted.

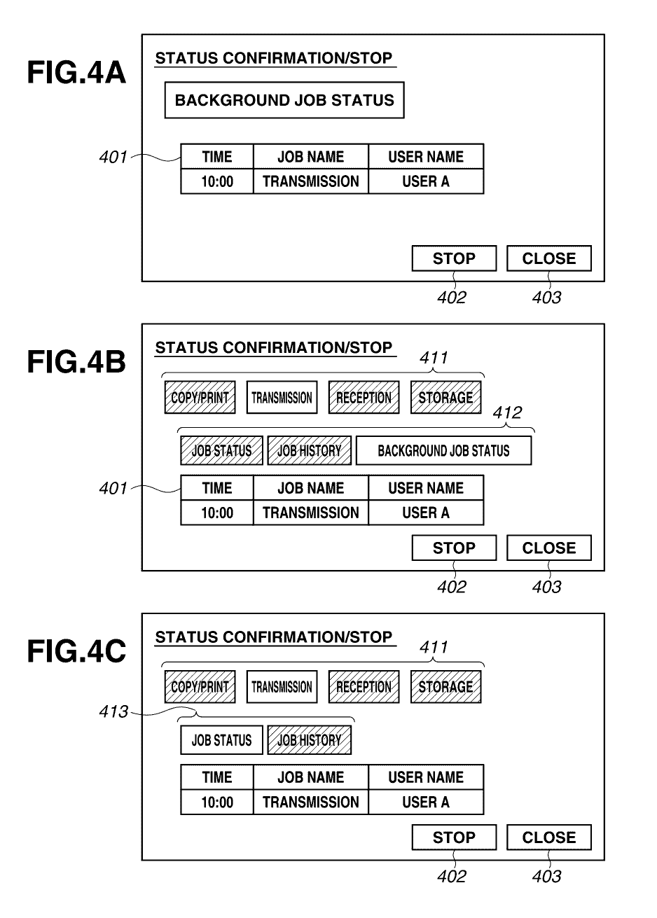

FIGS. 4A, 4B, and 4C illustrate examples of a status confirmation screen that can be displayed on an operation unit to indicate the status of each background job managed by the interrupt control unit 205. The status confirmation screen illustrated in FIG. 4A includes a background job status display field 401, which can be displayed on the display unit 119. In the display field 401, “time” indicates start time of the management target job, “job name” indicates type of the management target job, and “user name” indicates login name of the user who has instructed the execution of the management target job.

The interrupt control unit 205 refers to the interrupt management table (see FIG. 12) and, if the background job is present, identifies the job name based on the job identifier. The interrupt control unit 205 displays the identified job name (“transmission job” according to the illustrated example in FIG. 4A) on the operation unit.

Further, the interrupt control unit 205 refers to the interrupt management table (see FIG. 12) and identifies the user name based on the user identifier of the background job owner and displays the identified user name on the operation unit.

A stop key 402 is a key operable to stop the background job displayed in the display field 401. The stop key 402 is operable only when the login user is an administrator. Alternatively, it is feasible to enable a general user to stop a background job of another user. It is feasible to enable either the “administrator” or the “general user” to stop the background job.

The status confirmation screen can be closed by pressing a close key 403. According to the illustrated example in FIG. 4A, only one job is currently managed in the interrupt management table. However, the interrupt management table can be used to manage a plurality of jobs. In this case, after selecting a job, a user can press the stop key 402 to stop the selected target job.

FIG. 4B illustrates a screen that displays the other user's job that is currently in progress in the background during the interrupt login while displaying the status of currently progressing job or results of completed jobs.

A key group 411 is a group of keys operable to select the type of a job. FIG. 4B illustrates a state where the transmission job is selected.

A key group 412 is a group of keys, which includes a job status key operable to display the status of a job that is currently executed by a login user, a job history key operable to display results of jobs having been previously executed by the login user, and a background job status key operable to display a job that is currently in progress in the background. FIG. 4B illustrates a state where the background job status key is selected.

Therefore, the displayed content illustrated in FIG. 4B is the background job status display field 401. The content of the background job status (see the display field 401) is already described with reference to FIG. 4A and therefore redundant description thereof will be avoided.

A stop key 402 is a key operable to stop the background job displayed in the display field 401. A close key 403 can be pressed to close the screen illustrated in FIG. 4B.

FIG. 4C illustrates a screen that displays not only the job of the login user but also the job of the other user that is currently in progress in the background, while displaying the status of currently progressing job. In FIG. 4C, the key group 411 is a group of keys operable to select the type of a job. According to the illustrated example in FIG. 4C, the selected key is the transmission job key. A key group 413 includes a job status key operable to display the status of a job and a job history key operable to display results of jobs having been performed previously by the login user. According to the illustrated example in FIG. 4C, the selected key is the job status.

According to the illustrated example in FIG. 4C, only the status of the currently progressing background job status is displayed. The displayed content illustrated in FIG. 4C is the background job status display field 401.

A stop key 402 is a key operable to stop the background job displayed in the display field 401. The close key 403 can be pressed to close the screen illustrated in FIG. 4C.

In the present exemplary embodiment, a dedicated key 301 (illustrated in FIG. 3) is provided to display the screens illustrated in FIGS. 4A, 4B, and 4C. Alternatively, it can be configured to shift into any one of the status screens illustrated in FIGS. 4A, 4B, and 4C when an un-executable function key is pressed on the screen illustrated in FIG. 3. A job by which the function is currently un-executable can be promptly understood.

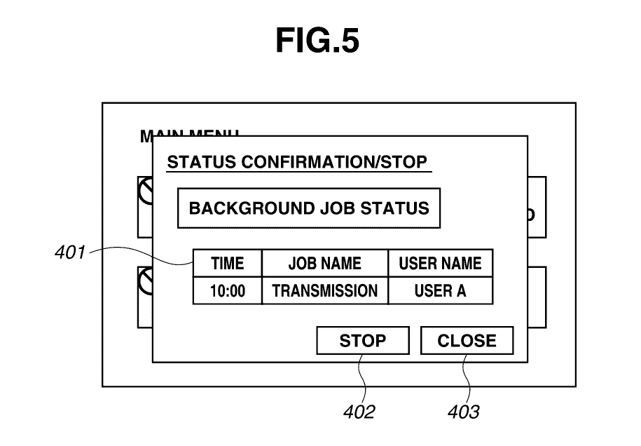

For example, FIG. 5 illustrates a displayed state of the background job status screen illustrated in FIG. 4A in a case where the copy function key has been pressed on the screen illustrated in FIG. 3. From the content illustrated in FIG. 5, it can be understood that the scanner is currently occupied to execute the transmission job designated by the user A and therefore the copy function is unavailable.

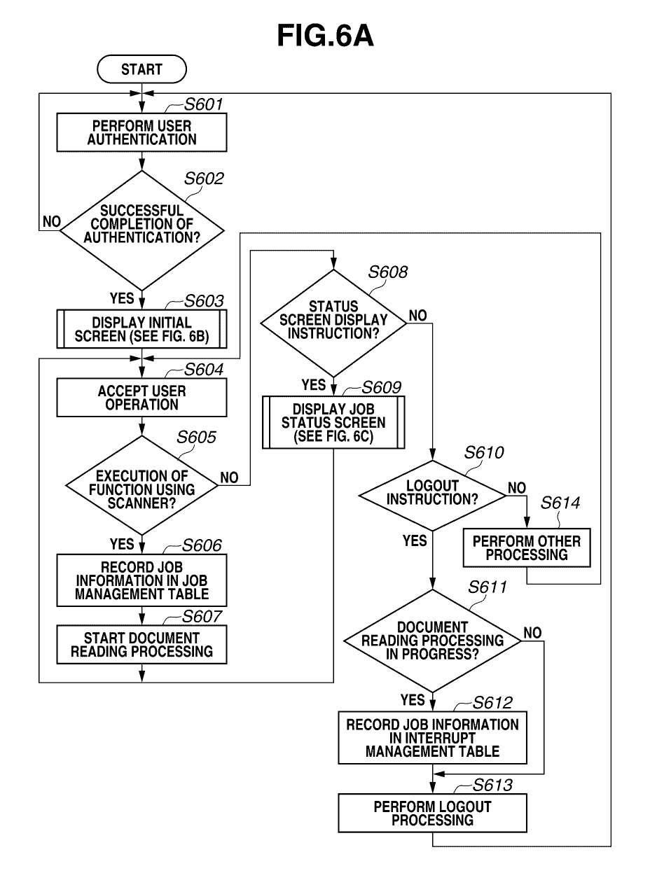

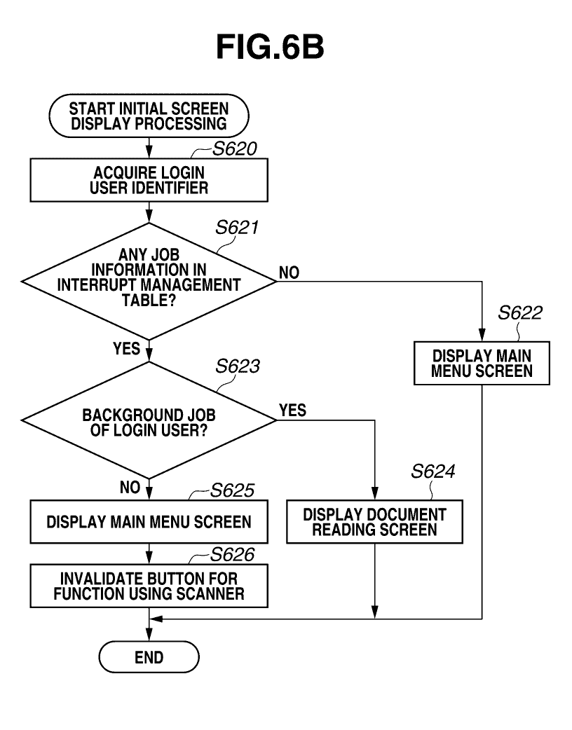

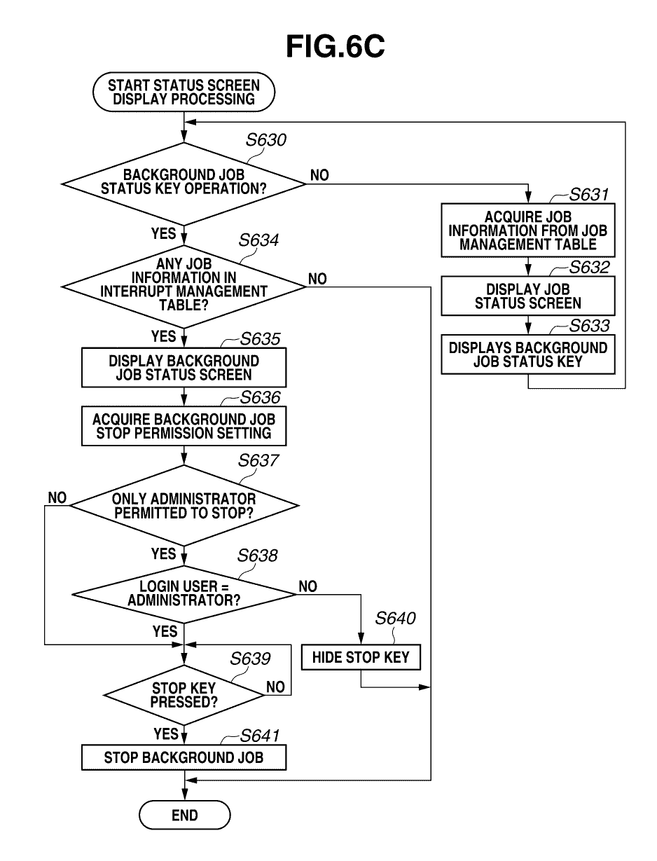

FIGS. 6A, 6B, and 6C are flowcharts illustrating processing that can be performed by the MFP 101. To realize each step of the flowcharts illustrated in FIGS. 6A, 6B, and 6C, the CPU 111 executes the related programs loaded from the ROM 113.

First, after the MFP 101 is activated, the display operation control unit 201 displays an authentication screen on the display unit 119 to accept authentication information including a user name and a password input via the authentication screen. If a user performs an input operation and the input information (user name and password) is transmitted to the authentication control unit 202 via the display control I/F 115, then in step S601, the authentication control unit 202 performs user authentication processing. More specifically, the authentication control unit 202 checks whether the transmitted information (e.g., user name and password) coincides with the information stored in the user information DB 220. As another method, an IC card can be used for the user authentication.

In step S602, the authentication control unit 202 checks whether the authentication has been successfully completed. If it is determined that the authentication has been successfully completed (YES in step S602), the operation proceeds to step S603. If the authentication has been failed (NO in step S602), the operation returns to step S601. In step S601, the authentication control unit 202 waits for an input from the user again.

In step S603, the display operation control unit 201 causes the display unit 119 to display an initial screen. The processing for displaying the initial screen will be described in detail below with reference to FIG. 6B.

In step S604, the display operation control unit 201 accepts an operation from the login user (i.e., the user authenticated in step S602). In step S605, the display operation control unit 201 determines whether executing the document scanning related function has been instructed. In the present exemplary embodiment, the display operation control unit 201 determines that the executing the document scanning related function has been instructed when any one of the copy function, the FAX function, the scan and send function, and the box saving function is selected on a menu screen illustrated in FIG. 3. If it is determined that executing the document scanning related function has been instructed (YES in step S605), the operation proceeds to step S606. If it is determined that executing the document scanning related function has not been instructed (NO in step S605), the operation proceeds to step S608.

In step S606, the job control unit 203 generates a job according to the user instruction accepted in step S604 and records job information in the job management table illustrated in FIG. 11. The job information includes job identifier, user identifier, job type, and job status (e.g., currently in progress, completed, and cancelled) as described above. Then, in step S607, the job control unit 203 starts the document reading processing instructed in step S604.

In the present exemplary embodiment, it is feasible to accept another user operation in step S604 after the reading processing has been started and before the reading processing is completed. Accordingly, for example, a user can input a logout instruction in a state where the reading processing is currently in progress after the reading processing has been started. If the user logs out before the reading processing completes, the job control unit 203 does not cancel the reading processing and continuously performs the reading processing.

In step S608, the display operation control unit 201 determines whether displaying a job status screen has been instructed. If the display operation control unit 201 determines that the display of the job status screen has been instructed (YES in step S608), the operation proceeds to step S609. If the display of the job status screen has not been instructed (NO in step S608), the operation proceeds to step S610.

In step S609, the display operation control unit 201 displays the job status screen. The processing to be performed in step S609 will be described in detail below with reference to FIG. 6C. On the other hand, in step S610, the authentication control unit 202 determines whether the logout has been instructed. If the authentication control unit 202 determines that the logout has been instructed (YES in step S610), the operation proceeds to step S611. If the logout has not been instructed (NO in step S610), the operation proceeds to step S614. In step S614, the display operation control unit 201 performs other instructed processing.

In step S611, the interrupt control unit 205 acquires the job information from the job control unit 203 and determines whether the document reading processing is currently in progress. If the interrupt control unit 205 determines that the document reading processing is currently in progress (YES in step S611), the operation proceeds to step S612. If it is determined that the document reading processing is not currently in progress (NO in step S611), the operation proceeds to step S613.

In step S612, the interrupt control unit 205 acquires information about the document reading job, which has been determined as being currently in progress in step S611, from the job control unit 203. Then, the interrupt control unit 205 records the acquired information, as background job information, in the interrupt management table illustrated in FIG. 12.

Next, in step S613, the authentication control unit 202 performs logout processing and terminates the processing of the flowchart illustrated in FIG. 6A.

The processing to be performed in step S603 will be described in detail below with reference to the flowchart illustrated in FIG. 6B. In step S620, the display operation control unit 201 acquires the user identifier of the login user (i.e., the user logged in step S602 of FIG. 6A) from the authentication control unit 202.

In step S621, the interrupt control unit 205 checks whether there is any scan-related background job. More specifically, the interrupt control unit 205 checks whether there is any information registered in the interrupt management table illustrated in FIG. 12. If there is information registered in the interrupt management table, the interrupt control unit 205 determines that the background job is present (YES in step S621), the operation proceeds to step S623. If there is not any registered information, the interrupt control unit 205 determines that the background job is not present (NO in step S621), the operation proceeds to step S622.

In step S622, the display operation control unit 201 displays a main menu that allows a user to operate each function key (e.g., any one of the copy, FAX, scan and send, and box saving keys). On the other hand, in step S623, the interrupt control unit 205 checks whether the background job whose information is registered in the interrupt management table is a job designated by the login user acquired in step S620. If the interrupt control unit 205 determines that the background job is the job designated by the login user (YES in step S623), the operation proceeds to step S624. If it is determined that the background job is not the job designated by login user (NO in step S623), the operation proceeds to step S625.

In step S624, the display operation control unit 201 acquires information from the job control unit 203 and displays a document reading screen that indicates the state of progress in the reading processing.

On the other hand, in step S625, the display operation control unit 201 displays the main menu that allows a user to operate each function key (e.g., any one of the copy, FAX, scan and send, and box saving keys). Then, in step S626, the display operation control unit 201 invalidates each function that uses the scanner 121 (e.g., copy, FAX, scan and send, and box saving functions) as illustrated in FIG. 3. The invalidation processing performed in step S626 restricts the usage of the scanner by the second user.

Next, the processing to be performed in step S609 will be described in detail below with reference to the flowchart illustrated in FIG. 6C.

In step S630, the display operation control unit 201 determines whether the background job status key or the status confirmation key has been operated. If the key having been operated is the background job status key (YES in step S630), the operation proceeds to step S634. If the key having been operated is the status confirmation key (NO in step S630), the operation proceeds to step S631. The key that displays the status of the background job can be the dedicated key 301 illustrated in FIG. 3 or can be displayed when the un-executable function key illustrated in FIG. 3 is pressed.

If it is determined that the status confirmation key has been operated (No in step S630), then in step S631, the display operation control unit 201 acquires job information from the job management table. Subsequently, the operation proceeds to step S632. In step S632, the display operation control unit 201 displays the job information acquired in step S631 on the job status screen (see the example illustrated in FIG. 4B).

In step S633, the display operation control unit 201 displays the background job status key. Then, the operation returns to step S630. On the other hand, if the determination result in step S630 determines that the background job status key is operated (YES in step S630), then in step S634, the interrupt control unit 205 checks whether there is any information registered in the interrupt management table (see FIG. 12). If it is determined that the interrupt management table includes the registered information (YES in step S634), the operation proceeds to step S635. If it is determined that the interrupt management table does not include any registered information (NO in step S634), the display operation control unit 201 displays a warning that informs no content to be displayed and then terminates the processing of the flowchart illustrated in FIG. 6C.

In step S635, the interrupt control unit 205 refers to the interrupt management table illustrated in FIG. 12 and identifies the job name based on the job identifier. Then, the interrupt control unit 205 displays the identified job name on the operation unit. Further, the interrupt control unit 205 refers to the interrupt management table (see FIG. 12) and identifies the user name stored in the user information DB 220 based on the user identifier of the background job owner. Then, the interrupt control unit 205 displays the identified user name on the display unit 119.

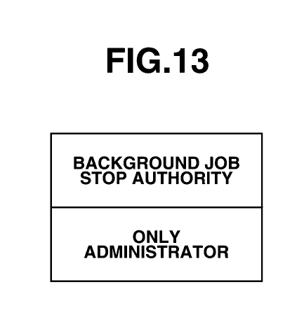

In step S636, the interrupt control unit 205 acquires stop authority information from the background job stop management table illustrated in FIG. 13.

In step S637, the interrupt control unit 205 refers to the information in the background job stop management table (FIG. 13) acquired in step S636. If the setting “only the administrator is permitted to stop” is registered in the background job stop management table (YES in step S637), the operation proceeds to step S638. If the setting “only the administrator is permitted to stop” is not registered in the table (NO in step S637), the operation proceeds to step S639.

FIG. 13 illustrates an example of a background job stop authority management table that is managed by the interrupt control unit 205. The table illustrated in FIG. 13 allows a user to set either “only the administrator is permitted to stop” or “general user can stop”. In the present exemplary embodiment, the administrator is a user who has work authority relating to operation and management of a copying machine.

The above-described settings can be made by a user. Desired content setting via an operation unit screen (not illustrated) is feasible. FIG. 13 indicates that the registered setting content is “only the administrator is permitted to stop”.

In step S638, the interrupt control unit 205 determines whether the user who has been authenticated is the administrator with reference to the user identifier of the user who has been authenticated in step S602. If it is determined that the user who has been authenticated is the administrator (YES in step S638), the operation proceeds to step S639. If it is determined that the user who has been authenticated is not the administrator (NO in step S638), the operation proceeds to step S640.

In step S640, the display operation control unit 201 hides the stop key to prevent the user from pressing the stop key and terminates the processing of the flowchart illustrated in FIG. 6C. On the other hand, in step S639, the display operation control unit 201 determines whether the stop key has been pressed. If it is determined that the stop key has been pressed (YES in step S639), the display operation control unit 201 notifies the interrupt control unit 205 of the job identifier of the target background job to be stopped.

In step S641, the interrupt control unit 205 notifies the job control unit 203 of the job identifier of the target to be stopped, which has been notified in step S639. The job control unit 203 stops the job. Further, the interrupt control unit 205 deletes the corresponding entry from the interrupt management table.

The above-described flowchart includes selectively displaying the stop key to control the authority to stop the background job. However, selectively displaying the background job will show similar effects.

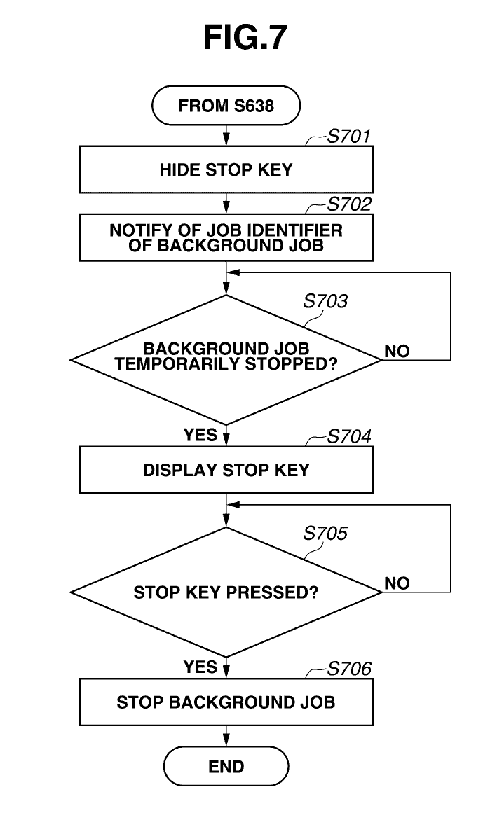

As described above, the processing according to the first exemplary embodiment is performed uniformly irrespective of the type of the background job. However, it is also feasible to change the processing content according to the state of the background job. Hereinafter, a control method for enabling a user to stop only the job that temporarily stops, for example, when the scanner shifts into a user input standby state will be described in detail below with reference to a flowchart illustrated in FIG. 7.

As described above, to realize the processing of each control unit, the CPU 111 executes the related program loaded from the ROM 113.

The following is detailed processing to be performed after the processing in step S638 illustrated in FIG. 6C is completed.

In step S701, the display operation control unit 201 hides the stop key. In step S702, the interrupt control unit 205 refers to the interrupt management table (see FIG. 12) and notifies the job control unit 203 of the job identifier of the background job. The interrupt control unit 205 requests the job control unit 203 to notify if the job is temporarily stopped.

Examples where the background job is temporarily stopped include the following cases. First, the background job will be temporarily stopped if the job includes a designation of preview to be performed before transmission and the job has shifted into a standby state to wait for a transmission start instruction from a user. Second, the background job will be temporarily stopped if the job includes a designation to perform continuous reading and the job has shifted into a standby state to wait for a user instruction with respect to whether to read the next original document or terminate the reading processing. Third, the background job will be temporarily stopped if an error (e.g., paper jam) has occurred during the job and the job has shifted into a standby state to wait for a user instruction with respect to a recovery operation to be performed by the user.

In step S703, the job control unit 203 checks the state of the background job. If the background job is temporarily stopped (YES in step S703), the job control unit 203 notifies the interrupt control unit 205 of the temporarily stopped state of the job. Then, the operation proceeds to step S704.

In step S704, the interrupt control unit 205 receives the notification from the job control unit 203 and requests the display operation control unit 201 to display the stop key. The display operation control unit 201 displays the stop key. In step S705, the display operation control unit 201 determines whether the stop key has been pressed. If it is determined that the stop key has been pressed (YES in step S705), the display operation control unit 201 notifies the interrupt control unit 205 of the job identifier of the target background job to be stopped.

In step S706, the interrupt control unit 205 notifies the job control unit 203 of the job identifier of the target to be stopped, which has been notified in step S705. The job control unit 203 stops the job. Further, the interrupt control unit 205 deletes the corresponding entry from the interrupt management table.

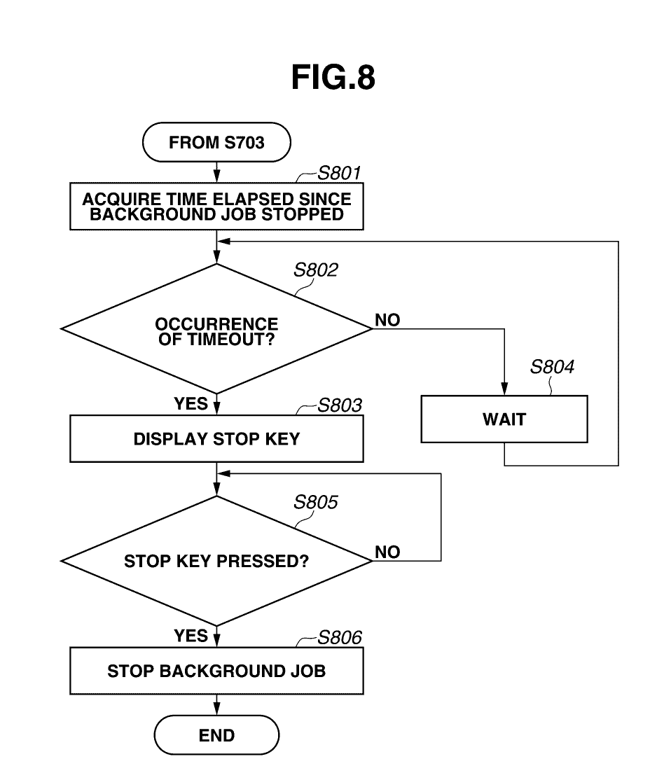

According to the processing described with reference to the flowchart illustrated in FIG. 7, pressing the stop key is feasible when the scan-related background job is temporarily stopped. It is also feasible to permit a user to stop the background job if elapse of a timeout time (i.e., a predetermined time having been set beforehand) is detected after the scan-related background job has been temporarily stopped. The timeout time can be arbitrary set by a user on the operation unit screen (not illustrated). Details of such processing will be described in detail below with reference to a flowchart illustrated in FIG. 8.

As described above, to realize the processing of each control unit, the CPU 111 executes the related program loaded from the ROM 113.

The detailed processing to be performed after the processing in step S703 illustrated in FIG. 7 is completed will be described.

In step S801, the interrupt control unit 205 measures the time elapsed since the time when the background job has been temporarily stopped. In step S802, the interrupt control unit 205 refers to a setting value of the timeout time and checks whether the time elapsed since the temporarily stopped timing of the background job acquired in step S801 has exceeded the timeout time value. If the interrupt control unit 205 determines that the elapsed time has exceeded the timeout time (YES in step S802), the operation proceeds to step S803. If the interrupt control unit 205 determines that the elapsed time has not exceeded the timeout time (NO in step S802), the operation proceeds to step S804. In step S804, the interrupt control unit 205 waits for the elapse of a predetermined time. Then, the operation returns to step S802, in which the interrupt control unit 205 checks the elapsed time again.

In step S803, the interrupt control unit 205 requests the display operation control unit 201 to display the stop key. Then, the display operation control unit 201 displays the stop key. In step S805, the display operation control unit 201 determines whether the stop key has been pressed. If it is determined that the stop key has been pressed (YES in step S805), the display operation control unit 201 notifies the interrupt control unit 205 of the job identifier of the target background job to be stopped.

In step S806, the interrupt control unit 205 notifies the job control unit 203 of the job identifier of the target to be stopped notified in step S805. Then, the job control unit 203 stops the job. Further, the interrupt control unit 205 deletes the corresponding entry from the interrupt management table.

In the above-described exemplary embodiment, the technique capable of stopping the background job has been described as a method for solving the problem that the down times becomes longer if a scan execution user moves away from the device for a long time.

As another method, it is feasible to forcibly perform the processing to cause the background job to complete, instead of stopping the background job, as described in detail below.

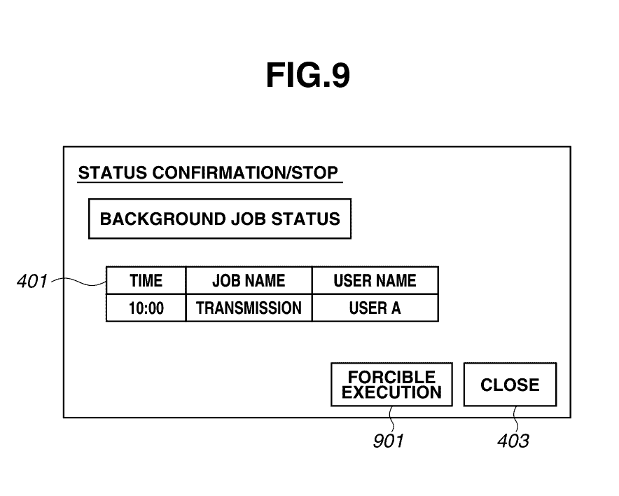

FIG. 9 illustrates an example state of a scan-related background job managed by the interrupt control unit 205, which is displayed on the operation unit.

The screen illustrated in FIG. 9 is similar to that illustrated in FIG. 4A in display content and key layout, except for a forcible execution key 901. The forcible execution key 901 is operable to forcibly execute the reading processing that is currently in progress in the background to cause the reading processing to complete.

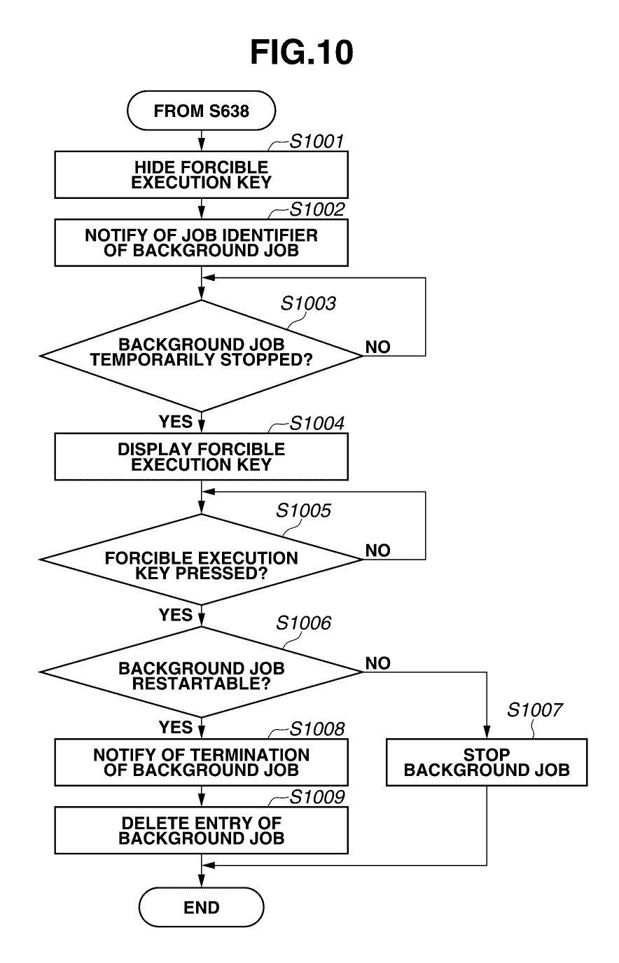

Next, example processing for forcibly executing the background job will be described in detail below with reference to a flowchart illustrated in FIG. 10.

As described above, to realize the processing of each control unit, the CPU 111 executes the related program loaded from the ROM 113.

After completing the processing in step S638 illustrated in FIG. 6C, in step S1001, the interrupt control unit 205 hides the forcible execution key 901.

In step S1002, the interrupt control unit 205 refers to the interrupt management table (see FIG. 12) and notifies the job control unit 203 of the job identifier of the background job. Then, the interrupt control unit 205 requests the job control unit 203 to notify if the job is temporarily stopped.

In step S1003, the job control unit 203 checks the state of the background job. If the background job is temporarily stopped (YES in step S1003), the job control unit 203 notifies the interrupt control unit 205 of the temporarily stopped state of the job. Then, the operation proceeds to step S1104.

In step S1004, the interrupt control unit 205 receives the notification from the job control unit 203 and requests the display operation control unit 201 to display the forcible execution key 901. The display operation control unit 201 displays the forcible execution key 901.

In step S1005, the display operation control unit 201 determines whether the forcible execution key 901 has been pressed. If it is determined that the forcible execution key 901 has been pressed (YES in step S1005), the display operation control unit 201 notifies the job control unit 203 of the job identifier of the target background job to be forcibly executed.

In step S1006, if it is feasible to cancel the temporarily stopped state of the job (YES in step S1006), the job control unit 203 cancels the temporarily stopped state of the job corresponding to the job identifier notified in step S1005, restarts the job, and then the operation proceeds to step S1008. If it is unfeasible to cancel the temporarily stopped state of the job (NO in step S1006), the job control unit 203 forcibly stops the job, and the operation proceeds to step S1007.

A job restart method will be described in detail below. For example, it is assumed that the background job is a scanned data transmission job and includes a setting to display the scanned data on the operation unit and transmit the scanned data after completing confirmation. In this case, the scan job is temporarily stopped to wait for a confirmation instruction input by a scan execution user. If the forcible execution key 901 is pressed in this state, it is confirmed that the confirmation instruction has been input and the transmission job is executed to complete the job.

In step S1007, the interrupt control unit 205 notifies the job control unit 203 of the job identifier of the target to be stopped, which has been notified in step S1006. Then, the job control unit 203 stops the job. Further, the interrupt control unit 205 deletes the corresponding entry from the interrupt management table. On the other hand, in step S1008, the job control unit 203 notifies the interrupt control unit 205 of termination of the job if the termination of the job restarted in step S1006 has been detected.

In step S1009, the interrupt control unit 205 deletes the corresponding entry from the interrupt management table.

According to the present exemplary embodiment, it is feasible to solve the problem that a copying machine cannot be used for a long time unless a background job completes when the job is operating in the background, by accepting an instruction from another user to cause the job to complete. As a result, the copying machine can be efficiently used.

As described above, according to each of the above-described exemplary embodiments, a second user can stop or complete document reading processing instructed by a first user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-150503, filed Jul. 30, 2015, which is hereby incorporated by reference herein in its entirety.

What is claimed is:

1. An image reading apparatus comprising:
a reading unit configured to perform reading processing for reading an original document;
a control unit configured to permit a second user, different from a first user, to use at least one function of the image reading apparatus if the at least one function does not use the reading unit and restrict usage of a function using the reading unit until the reading processing completes, based on a login of the second user into the image reading apparatus while execution of the reading processing continues after the first user logs out of the image reading apparatus while the reading processing is in progress based on an instruction from the first user who logged into the image reading apparatus; and
an acceptance unit configured to accept an instruction from the second user to stop or restart the reading processing that was temporarily stopped to wait for at least a user instruction while the usage of the function using the reading unit is restricted.

2. The image reading apparatus according to claim 1, further comprising a detection unit configured to detect a temporarily stopped state of the reading processing in a standby state to wait for a user instruction,
wherein the acceptance unit accepts an instruction from the second user to stop the reading processing started based on the instruction from the first user and the temporarily stopped state has been detected and does not accept the instruction from the second user to stop the reading processing started based on the instruction from the first user and the temporarily stopped state has not been detected.

3. The image reading apparatus according to claim 2, further comprising a checking unit configured to check whether a predetermined time has elapsed since the detection that the reading processing was temporarily stopped,
wherein the acceptance unit accepts from the second user an instruction to stop the temporarily stopped reading processing if the checking unit determines that the predetermined time has elapsed and does not accept an instruction to stop the temporarily stopped reading processing if the checking unit determines that the predetermined time has not yet elapsed.

4. The image reading apparatus according to claim 1, further comprising a detection unit configured to detect a temporarily stopped state of the reading processing due to occurrence of an error,
wherein the acceptance unit accepts from the second user an instruction to stop the reading processing if the reading processing started based on the instruction from the first user and the temporarily stopped state has been detected and does not accept the instruction to stop the reading processing from the second user if the reading processing started based on the instruction from the first user and the temporarily stopped state has not been detected by the detection unit.

5. The image reading apparatus according to claim 1, wherein while the reading processing is in progress based on an instruction from the first user logged into the image reading apparatus, if the first user logs out of the image reading apparatus and then logs back into the image reading apparatus while the execution of the reading processing continues, the control unit permits the first user to use the function using the reading unit.

6. The image reading apparatus according to claim 1, wherein while the reading processing is in progress based on an instruction from the first user logged into the image reading apparatus, if the first user logs out of the image reading apparatus and then the second user logs into the image reading apparatus while the execution of the reading processing continues, the reading processing is performed in the background.

7. The image reading apparatus according to claim 1, further comprising a determination unit configured to check authority of the second user and determine whether the second user has authority to stop or complete the reading processing performed based on an instruction from another user,
wherein if the determination unit determines that the second user has the authority, the acceptance unit accepts an instruction to stop or restart the reading processing temporarily stopped to wait for at least a user instruction from the second user.

8. The image reading apparatus according to claim 1, further comprising a display unit configured to display a status confirmation screen for confirming a status of the reading processing,
wherein the acceptance unit accepts an instruction to stop or complete the reading processing via the status confirmation screen.

9. The image reading apparatus according to claim 1, wherein the reading processing includes a designation of preview to be performed before transmission of data generated by the reading processing.

10. The image reading apparatus according to claim 1, wherein the reading processing includes continuous reading.

11. The image reading apparatus according to claim 1, wherein the control unit prevents the function using the reading unit from being selected by the second user.

12. A method for controlling an image reading apparatus equipped with a reading unit configured to perform reading processing for reading an original document, the method comprising:
enabling a first user to log into the image reading apparatus;
performing reading processing for reading an original document based on an instruction from the first user who is logged into the image reading apparatus;
logging the first user out of the image reading apparatus while the reading processing is in progress;
enabling a second user to log into the image reading apparatus while execution of the reading processing continues;
permitting the second user to use at least one function of the image reading apparatus if the at least one function does not use the reading unit and restricting usage of a function using the reading unit until the reading processing completes, based on a login of the second user in the image reading apparatus; and
accepting an instruction from the second user to stop or restart the reading processing that was temporarily stopped to wait for at least a user instruction while restricting the usage of the function using the reading unit by the second user.

13. A computer-readable storage medium storing computer executable instructions for causing a computer to perform a control method for an image reading apparatus equipped with a reading unit configured to perform reading processing for reading an original document, the control method comprising:
enabling a first user to log into the image reading apparatus;
performing reading processing for reading an original document based on an instruction from the first user who is logged into the image reading apparatus;
logging the first user out of the image reading apparatus while the reading processing is in progress;
enabling a second user to log into the image reading apparatus while execution of the reading processing continues;
permitting the second user to use at least one function if the at least one function does not use the reading unit and restricting usage of a function using the reading unit until the reading processing completes, based on a login of the second user into the image reading apparatus; and
accepting an instruction from the second user to stop or restart the reading processing that was temporarily stopped to wait for at least a user instruction while restricting the usage of the function using the reading unit by the second user.
